(19) United States
(12) Patent Application Publication
(10) Pub. No.: US 2009/0187692 A1
(43) Pub. Date: Jul. 23, 2009

(54) Stick-On USB Drive Holder

(76) Inventors: Nicholas Michael Czarnek, Johnstown, PA (US); Robert Czarnek, Johnstown, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/356,717

(22) Filed: Jan. 21, 2009

Related U.S. Application Data
(60) Provisional application No. 61/021,983, filed on Jan. 18, 2008.

(51) Int. Cl. G06F 13/00

(52) U.S. Cl. 710/300

(57) ABSTRACT

A holder for a USB drive is disclosed. The holder can be used as a stand-alone product, or as a retrofit to notebooks and binders, or as an integrated part of such a binder. A holder includes a backing, a pouch coupled to the backing and defining with the backing a cavity for receiving a USB drive such that a portion of the USB drive extends out of the cavity. The holder can include a tab, a leaf spring, a combination spring-loaded plunger and holding plate, or a securable flap for securing the USB drive in the cavity.

### CROSS-REFERENCE TO RELATED APPLICATION

This application claims priority from U.S. Provisional Patent Application No. 61/021,983, filed on Jan. 18, 2008, which is incorporated herein by reference. Since, Jan. 18, 2009 was a Sunday, since Jan. 19, 2009 was a federal holiday, and since the U.S. Patent and Trademark Office was closed on Jan. 20, 2009 for inauguration day, this application (filed on Jan. 21, 2009) is entitled to the benefit of the filing date of the above-identified provisional patent application under 37 C.F.R. §1.7.

### BACKGROUND OF THE INVENTION

USB memory drives, also known as memory sticks, come in various shapes and sizes. They serve to store important information in digital form. Their loss can result in high cost loss of data. Typically the drives that can be found on the market come with straps or holes that allow their user to hang them on his neck, key-chain or belt. If the user wants to attach the USB drive to a document or binder, it is often inconvenient to do so with current accessory attachment devices.

### SUMMARY OF THE INVENTION

The invention is a USB drive holder that includes a backing, a pouch coupled to the backing and defining a cavity for receiving a USB drive such that a portion of the USB drive extends out of the cavity, and means for securing the USB drive in the cavity.

The means for securing the USB drive in the cavity can include:

a projection that applies to a body of the USB drive received in the cavity a normal force that frictionally secures the USB drive in the cavity;

a leaf spring that applies to a body of the USB drive received in the cavity a normal force that frictionally secures the USB drive in the cavity;

a spring-loaded plunger in the cavity and holding plate outside the cavity, the spring-loaded plunger and the holding plate arranged to clamp the USB drive therebetween; and/or

a flap having a fixed end and a moveable end, the fixed and moveable ends of the flap arranged whereupon the moveable end of the flap is moveable to cover at least part of the portion of the USB drive that extends out of the cavity and a fastener for securing the moveable end of the flap in a position covering at least part of the portion of the USB drive that extends out of the cavity.

The USB drive holder can further include means for securing the backing to a surface. The means for securing the backing can include an adhesive or an adhesive tape.

The USB drive holder can further include means for securing the pouch to a backing. The means for securing the pouch can include an adhesive, welding, or stitching.

### BRIEF DESCRIPTION OF THE DRAWINGS

FIG. 1A is a perspective view of a first embodiment USB holder including a pouch having a friction button for securing a USB drive in the pouch;

FIG. 1B is a cross-sectional side view of the USB holder of FIG. 1A;

FIG. 2 is a perspective view of a second embodiment USB holder including a pouch having a molded leaf-spring for securing a USB drive in the pouch;

FIG. 3A is a perspective view of a third embodiment USB holder having a holding plate and a spring-loaded plunger for securing a USB drive in a fixed position therebetween;

FIG. 3B is a cross-sectional side view of the USB holder of FIG. 3A;

FIG. 4 is a perspective view of a fourth embodiment USB holder including a pouch for receiving a USB drive and a flap and a fastener for securing the USB drive in the pouch;

FIG. 5 is a perspective view of a fifth embodiment USB holder including a pouch that can be coupled to any suitable surface to define a cavity for receiving a USB drive and a combination attachment tab/flap/fastener, wherein the attachment tab can be connected to a location of the surface relative to the pouch so that the flap can cover the open end of the cavity when the USB drive is received therein;

FIG. 6 is a perspective view of a sixth embodiment USB holder including a pouch for receiving a USB drive and a clasp positioned above the pouch for engaging an end of the USB drive that extends out of the pouch, whereupon the pouch and the clasp are configured to apply to the USB drive a compressive force that secures (clasps) the USB drive in the pouch;

FIG. 7 illustrates the fourth embodiment USB holder on a spine 20 of a binder 19; and

FIG. 8 illustrates use of a double-stick tape for attaching any embodiment USB holder having a backing to a surface of choice.

### DETAILED DESCRIPTION OF THE INVENTION

The present invention is a USB holder that can be attached to various surfaces, such as the spine of a binder, a computer case, the front of a notebook, a file cabinet, etc. The USB holder includes a pouch with a means, such as a snap, a button, friction fit, or Velcro® fastener that prevents a USB drive received in the pouch from falling out. On a side of the USB holder opposite the pouch, the USB holder will have means, such as double-stick tape or any other adhesive media or Velcro®, to attach the USB holder to a surface. The USB holder can be molded out of rigid or elastic polymers, such as rubber and plastics, or it can be formed from various materials, including polymers, fabrics, etc. The USB holder can be molded to be streamlined in a way that would prevent accidental detachment from the surface to which it is attached. Proper selection of materials will allow not only convenient storage of a USB drive, but also protection of the USB drive from accidental damage, in particular, the connector of the USB drive.

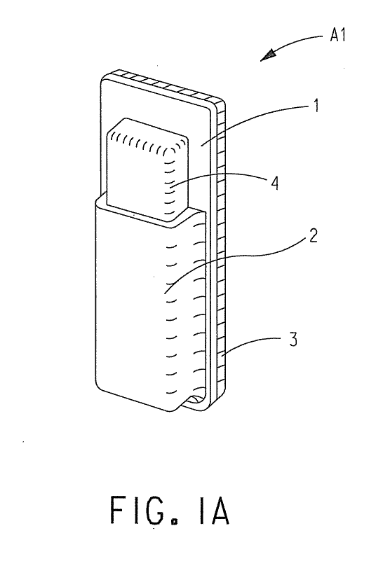

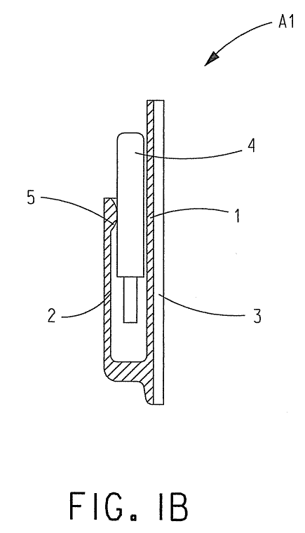

FIG. 1A depicts an embodiment of a USB holder A1 that is molded out of rigid or semi-rigid plastic. USB holder A1 is fitted to a particular model of USB drive 4 and is intended to be sold with USB drive 4. USB holder A1 includes a rigid backing or back plate 1 that provides structural support for a pouch 2 and attachment surface for a double-stick adhesive tape 3. Back plate 1 and pouch 2 define a cavity for receiving USB drive 4 with a portion of USB drive 4 extending from the cavity. USB drive 4 is held in place in the cavity by a molded button or projection 5 shown in FIG. 1B that frictionally holds USB drive 4 in the cavity. Elastic deformation of pouch 2 provides a normal force between the body of USB drive 4 and molded button 5 that defines the friction fit between USB drive 4 and pouch 2 or back plate 1. If desired, molded button 5 can be disposed on back plate 1 instead of or in addition to molded button 5 being disposed on pouch 2 as shown in FIG. 1B.

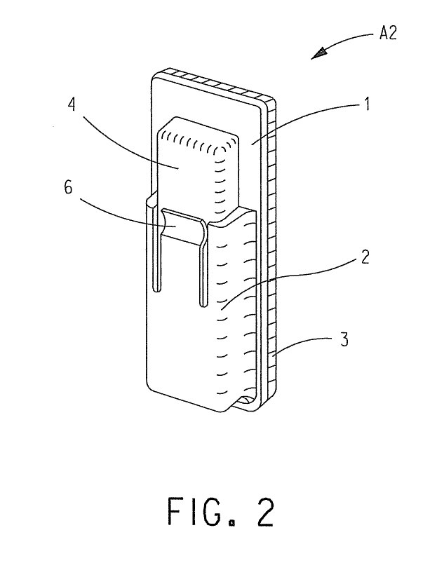

FIG. 2 depicts another embodiment USB holder A2 molded out of rigid or semi-rigid plastic. In this embodiment, friction button 5 of USB holder A1 is replaced by a leaf spring 6 formed as part of USB holder A2. All other parts, back plate 1, pouch 2 and adhesive tape 3 are the same as in USB holder A1 shown in Figs. 1A and 1B. The geometry of spring 6 allows for much larger range of motion of the contact point between the spring 6 and the body of USB drive 4. This, in turn, allows accommodating a wider variety of USB drives 4 that this embodiment can be used with, making it a universal holder.

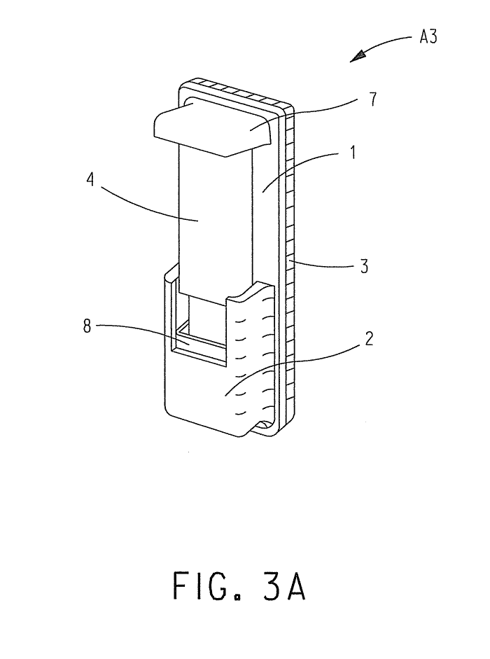

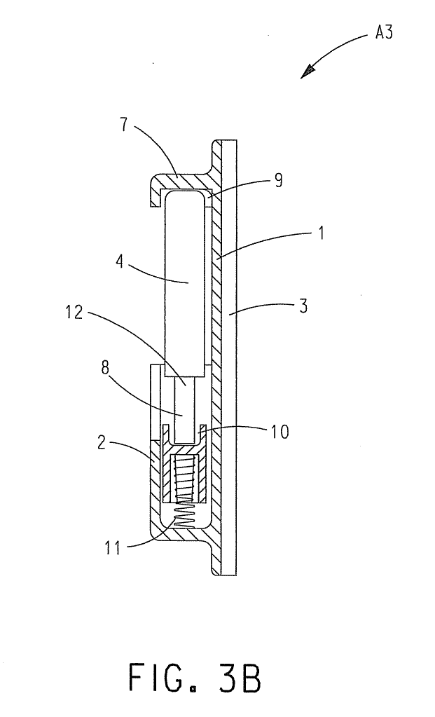

FIG. 3A depicts another embodiment USB holder A3 molded out of rigid or semi-rigid plastic. This embodiment is designed as a universal holder capable of accommodating different form factor USB drives 4. It includes back plate 1, pouch 2, a holding plate 7 and adhesive layer 3. As shown in FIG. 3B, pouch 2 houses a spring 11 loaded plunger 8. Spring 11 biases plunger 8 against the USB connector 12 of USB drive 4 located in cavity 10 formed in plunger 8. The other end of the USB drive 4 rests in a cavity 9 formed in a holding plate 7.

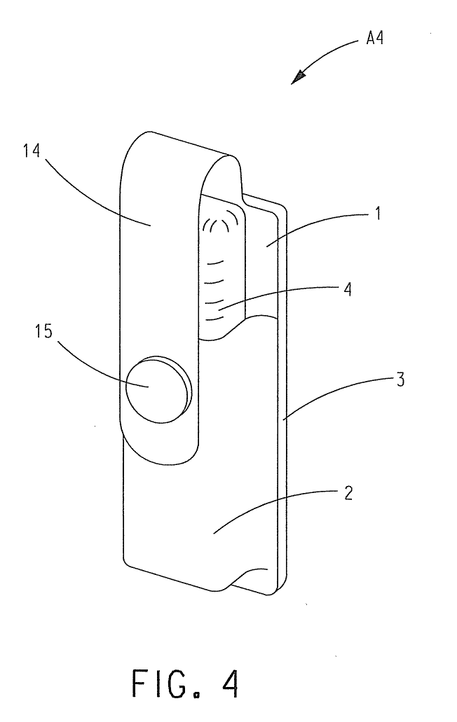

FIG. 4 depicts another embodiment USB holder A4 made of a plastic sheet. USB holder A4 includes a backing 1 that incorporates a flexible strip forming a holding flap 14. A flexible pouch 2 is attached to backing 1 in FIG. 4 along its edges. A fastener 15 allows securing flap 14 to pouch 2. Adhesive layer 3, such as a double-stick tape, can be attached to the back surface of backing 1. This adhesive allows attachment of USB holder A4 to a notebook or any other surface of choice. Fastener 15 can be a snap-fastener, a Velcro® fastener or any other means of securing two surfaces together. USB holder A4 can be a stand-alone product used for retrofitting existing binders, or sold as part of a binder.

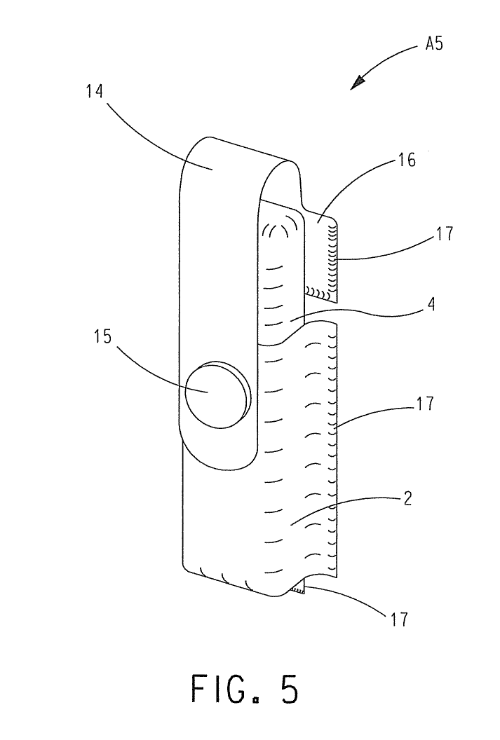

FIG. 5 depicts another embodiment USB holder A5 intended as an integral part of a binder or notebook which defines the backing of USB holder A5, e.g., like backing 1 of USB holder A1. Made of flexible sheet of appropriate material such as plastic or fabric, pouch 2 of USB holder A5 can be attached to the chosen surface (backing) by the means of welding or stitching or by the use of adhesive along a joint line 17 thereof. FIG. 5 illustrates an embodiment where the combination of flap 14 and attachment tab 16 is manufactured as a separate piece from the sheet forming the pouch 2. Attachment tab 16 can also be attached to the chosen surface (backing) by the means of welding or stitching or by the use of adhesive along a joint line 17 thereof. Without changing the idea of this invention, USB holder A5 can be manufactured using one continuous piece of material.

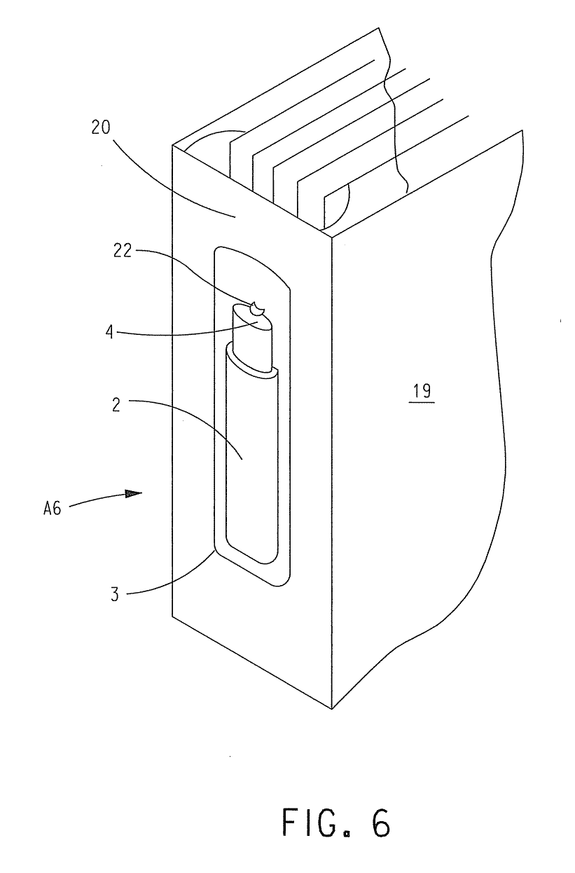

FIG. 6 depicts another embodiment USB holder A6 attached to the spine 20 of a binder 19. USB holder A6 includes a rigid pouch 2 with a holding mechanism in the form of a clasp 22 for engaging an end of the USB drive that extends out of the pouch 2. For the purpose of illustration, USB holder A6 is shown located on the outside of binder 19. However, any suitable and/or desirable location chosen by a user is equally acceptable providing it offers sufficient surface for attaching USB holder A6. For example, USB holder A6 can be attached to the inside of the cover of binder 19.

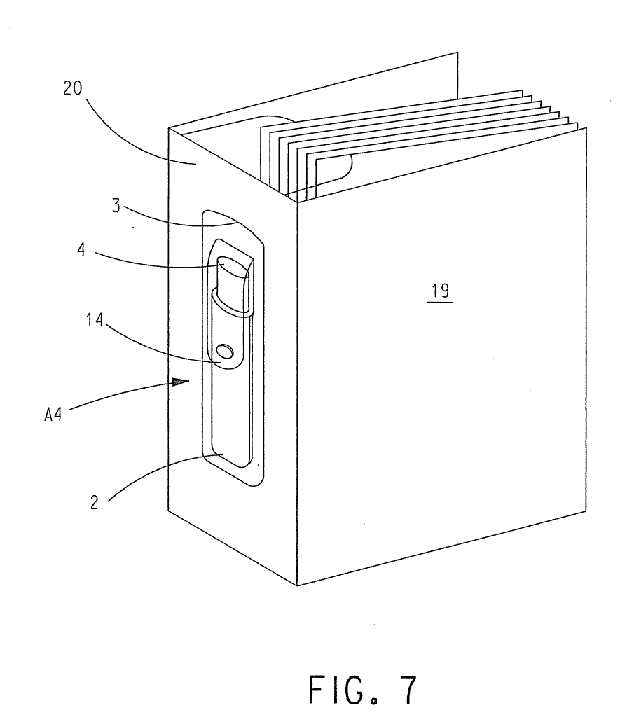

FIG. 7 illustrates the application of USB holder A4 to the spine 20 of binder 19.

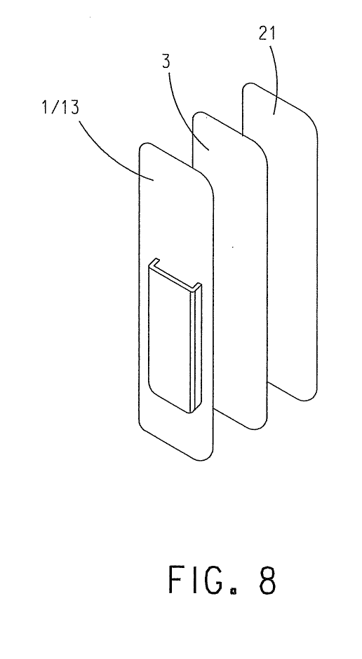

Lastly, FIG. 8 illustrates use of double-stick tape 3 as a means of attaching any embodiment USB holder having backing 1 to a surface of choice. Double-stick tape 3 is applied to the back surface of the backing 1 or back foil 13. Wax paper 21 can be used to protect double-stick tape 3 during shipping and storage.

The present invention has been described with reference to the preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A USB drive holder comprising:
a backing;
a pouch coupled to the backing and defining a cavity for receiving a USB drive such that a portion of the USB drive extends out of the cavity; and
means for securing the USB drive in the cavity.

2. The USB drive holder of claim 1, wherein the means for securing the USB drive in the cavity includes a projection that applies to a body of the USB drive received in the cavity a normal force that frictionally secures the USB drive in the cavity.

3. The USB drive holder of claim 1, wherein the means for securing the USB drive in the cavity includes a leaf spring that applies to a body of the USB drive received in the cavity a normal force that frictionally secures the USB drive in the cavity.

4. The USB drive holder of claim 1, wherein the means for securing the USB drive in the cavity includes a spring-loaded plunger in the cavity and holding plate outside the cavity, the spring-loaded plunger and the holding plate arranged to clamp the USB drive therebetween.

5. The USB drive holder of claim 1, wherein the means for securing the USB drive in the cavity includes:
a flap having a fixed end and a moveable end, the fixed and moveable ends of the flap arranged whereupon the moveable end of the flap is moveable to cover at least part of the portion of the USB drive that extends out of the cavity; and
a fastener for securing the moveable end of the flap in a position covering at least part of the portion of the USB drive that extends out of the cavity.

6. The USB drive holder of claim 1, further including means for securing the backing to a surface.

7. The USB drive holder of claim 6, wherein the means for securing the backing includes an adhesive or an adhesive tape.

8. The USB drive holder of claim 1, further including means for securing the pouch to a backing.

9. The USB drive holder of claim 6, wherein the means for securing the pouch includes an adhesive, welding, or stitching.
